(19) United States
(12) Patent Application Publication
(10) Pub. No.: US 2005/0093336 A1
(43) Pub. Date: May 5, 2005

(54) Door panel with self-gripping hooks

(75) Inventor: Fabrice Billarant, Nantes (FR)

Correspondence Address: Edward G. Greive;Renner, Kenner, Greive, Bobak, Taylor & Weber, Fourth Floor, First National Tower, Akron, OH, 44308-1456, US

(73) Assignee: APLIX

(21) Appl. No.: 10/963,958

(22) Filed: Oct. 12, 2004

(30) Foreign Application Priority Data
Oct. 29, 2003 (FR) 03 12639

(51) Int. Cl. B60J 5/00

(52) U.S. Cl. 296/146.7

(57) ABSTRACT

Door panel assembly of an automobile, having a door panel 1 and a sound-insulating sheet 4 attached to the door panel, characterised in that the door panel has hooks on its surface to which the sound-insulating sheet is attached, and a looped knitted fabric or a looped non-woven fabric 6′ is attached to the surface of the sound-insulating sheet to be attached to the panel, the looped knitted or non-woven fabric weighing between 15 and 60 g/m², preferably between 15 and 40 g/m².

The present invention relates to body panels for automobiles, in particular door panels on which is fixed a sheet having sound-insulating properties.

In current panels, attachment is carried out by fusing synthetic material pins which are inserted into a housing of the door panel and which are made by means of an injection process, by ultrasonic welding of compatible materials, or by a process using adhesive, in particular using hot melt adhesive points.

These techniques are long and troublesome, in particular owing to the point-wise application and owing to the fact that these techniques have to be carried out in two stages, the first stage being the positioning in the panel and the second stage being its attachment to the panel.

Furthermore, once the sound-insulating sheet is fixed, its position can no longer be modified such that it is necessary to provide complex tooling to ensure that the sheet is fixed in the correct position when it is first placed.

Finally, the presence of numerous weld or adhesive points within the sound-insulating sheet itself has a disadvantageous effect on its air flow resistance characteristic, and thus reduces its sound-insulating properties.

The present invention aims to create a door panel assembly, wherein it is simple and quick to attach (in particular in a single step) a sound-insulating sheet, generally in the form of a felt, a foam or a non-woven fabric, and in particular wherein the sound-insulating sheet is guaranteed to be correctly positioned at the end of the attachment step without having to provide complex tooling or having to repeat a long and troublesome attachment process, in particular by means of local application in numerous points on the sound-insulating sheet/panel interface, and the sound-insulating quality also being improved.

In accordance with the invention, a door panel assembly of an automobile, having a door panel and a sound-insulating sheet attached to the door panel, is characterised in that the door panel has hooks on its surface facing the sound-insulating sheet and a looped knitted fabric or a looped non-woven fabric is attached to the surface of the sound-insulating sheet facing the panel, the looped knitted or non-woven fabric weighing between 15 and 60 g/m², preferably between 15 and 40 g/m².

By thus providing a system with hooks and a looped knitted or non-woven fabric, a system is obtained which is particularly simple for the quick, firm attachment of the sound-insulating sheet, in the correct position, to the door panel, whilst furthermore providing improved sound-insulating properties with respect to the Prior Art.

In accordance with a preferred embodiment, the hooks issue from one part of the door panel, the hooks being produced in particular by an injection moulding process.

In accordance with a preferred embodiment, the sound-insulating sheet is a felt, in particular weighing between 40 and 500 g/m².

In accordance with a preferred embodiment, the sound-insulating sheet is a foam, the sheet being attached to the looped knitted or non-woven fabric in particular by means of a foaming process.

In accordance with a preferred embodiment, the panel surface intended to receive the sheet has hooks disposed on small regions, preferably from 1 to 5 cm², mutually-spaced apart, in particular in a regular manner, in particular in a ratio of 5 to 25 per m² of the panel.

The foaming process consists of melting the foam to attach it to the knitted fabric.

The present invention also relates to a laminated structure forming the sound-insulating sheet, comprising a sound-insulating sheet, in particular of foam, non-woven fabric or felt, and weighing in particular between 40 and 500 g/m², characterised by a looped knitted or non-woven fabric which is attached, in particular by means of adhesive, a foaming process or other method, to the sound-insulating sheet, in particular over the whole of one side of the sheet, the looped knitted or non-woven fabric weighing between 15 and 60 g/m², preferably between 15 and 40 g/m².

One embodiment of the invention is shown in the drawings which are given by way of example only and in which:

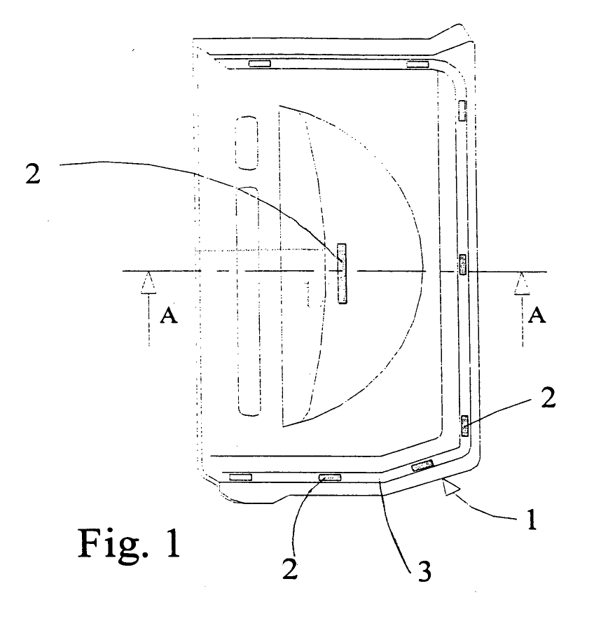

FIG. 1 schematically shows a view of a door panel in accordance with the invention,

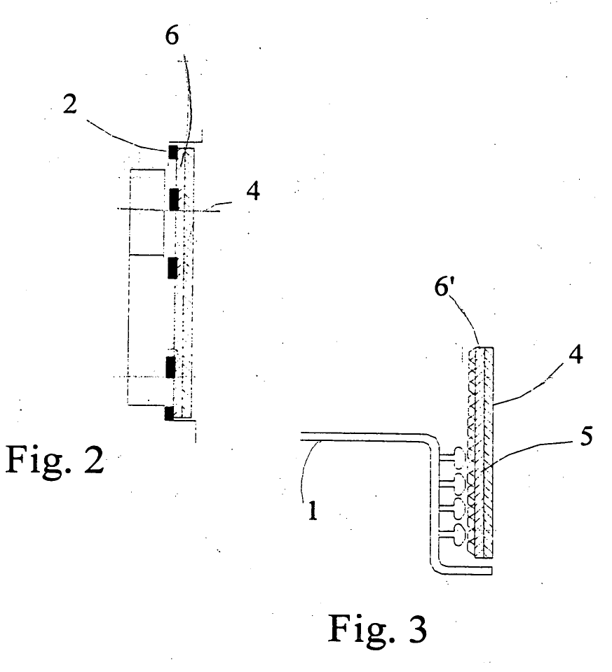

FIG. 2 shows a cross-sectional view taken along line A-A of the panel of FIG. 1 to which a laminated structure forming the sound-insulating sheet is attached, and

FIG. 3 shows a part of FIG. 2 in a larger scale.

With reference to the Figures, the door panel assembly of an automobile comprises a panel 1, in particular of synthetic material for example, having a surface 3 with hooks 2 which issue therefrom and are formed by an injection moulding process. A method for producing a panel having moulded hooks of this type is described in particular in European Patent no. 0577697 in the name of Aircast Inc.

The hooks 2 may also be produced separately, e.g. in the form of a batt of hooks which is subsequently attached by means of adhesive to the panel.

In accordance with a preferred alternative embodiment, the surface 3 comprises a network of small hooked regions, preferably from 1 to 5 cm², mutually spaced apart in a ratio of 5 to 25 per m² of the panel, in particular following a regular arrangement.

The panel assembly also comprises a sound-insulating sheet assembly. This sheet assembly is formed from a sheet 4 of sound-insulating material, for example of PETON PP, in the form of a non-woven fabric. The sheet 4 can also be a felt or a foam The sheet 4 weighs between 40 and 500 g/m², in particular between 60 g/m² and 200 g/m².

A looped knitted fabric 6, for example comprising an interlacing of weft threads, wale threads and looped threads, is laminated onto a surface 5 of the sound-insulating sheet 4.

The knitted fabric weighs between 15 g/m² and 60 g/m², in particular between 15 and 40 g/m².

This adhesion process can be effected in particular in accordance with the method described in French Patent no. 96 082 59 in the name of the Applicant or by any other well known adhesion, welding, melting, or other, process.

In accordance with another embodiment, a looped non-woven fabric 6′, or plush loop, is attached by means of adhesive to the surface 5 of the sheet 4.

The looped non-woven fabric weighs between 15 and 60 g/m², preferably between 15 and 40 g/m².

Preferably, the whole of the surface 5 is covered by the knitted fabric 6 or the non-woven fabric 6′, or a combination of the two.

The hooks have a height h which measures in particular between 0.3 and 3.5 mm.

1. A door panel assembly of an automobile, having a door panel and a sound-insulating sheet attached to the door panel, characterised in that the door panel has hooks on its surface to which the sound-insulating sheet is attached, and a fabric is attached to the surface of the sound-insulating sheet to be attached to the panel, the fabric weighing between 15 and 60 g/m², preferably between 15 and 40 g/m².

2. The assembly of claim 1 wherein the fabric is a looped knitted fabric.

3. The assembly of claim 1 wherein the fabric is a non-woven fabric.

4. The assembly of claim 1, characterised in that the hooks issue from one part of the door panel, the hooks being produced in particular by means of an injection moulding process.

5. The assembly of claim 2, characterised in that the surface of the panel which will receive the sheet has hooks disposed over small regions, preferably from 1 to 5 cm², mutually spaced apart, in particular in a regular manner, in particular in a ratio of 5 to 25 per m² of the panel.

6. The assembly of claim 1, characterised in that the fabric covers all of the surface of the sheet.

7. The assembly of claim 1, characterised in that the hooks have a height measuring between 0.3 and 3.5 mm.

8. The assembly of claim 1, characterised in that the sound-insulating sheet is a felt, in particular weighing between 40 and 500 g/m².

9. The assembly of claim 1, characterised in that the sound-insulating sheet is a foam and is attached to the fabric by means of a foaming process.

10. A door panel for an assembly as claimed in claim 1, characterised by hooks issuing from one surface of the panel, the hooks having a height measuring between 0.3 mm and 3.5 mm.

11. A panel as claimed in claim 10, characterised in that the panel has hooks, the surface of the panel which will receive the sheet has hooks disposed over small regions, preferably from 1 to 5 cm², mutually spaced apart, in particular in a regular manner, in particular in a ratio of 5 to 25 per m² of the panel.

12. The assembly of claim 1, characterised in that the surface of the panel which will receive the sheet has hooks disposed over small regions, preferably from 1 to 5 cm², mutually spaced apart, in particular in a regular manner, in particular in a ratio of 5 to 25 per m² of the panel.

13. A laminated structure forming the sound-insulating sheet for an assembly as claimed in claim 1, comprising a sound-insulating sheet characterised by a fabric which is attached to the sound-insulating sheet, the fabric weighing between 15 and 60 g/m², preferably between 15 and 40 g/m², the fabric covering the sound-insulating sheet over the whole of one side of the sheet.
